(19) United States
(12) Patent Application Publication
(10) Pub. No.: US 2018/0137876 A1
(43) Pub. Date: May 17, 2018

(54) Speech Signal Processing System and Devices

(71) Applicant: Hitachi, Ltd., Tokyo (JP)

(72) Inventors: Qinghua SUN, Tokyo (JP); Ryoichi TAKASHIMA, Tokyo (JP); Takuya FUJIOKA, Tokyo (JP)

(21) Appl. No.: 15/665,691

(22) Filed: Aug. 1, 2017

(30) Foreign Application Priority Data
Nov. 14, 2016 (JP) 2016-221225

(51) Int. Cl. G10L 21/0216; G06F 17/28

(52) U.S. Cl. CPC G10L 21/0216; G10L 2021/02166; G06F 17/28

(57) ABSTRACT

In a speech signal processing device including a plurality of devices and a speech signal processing device, a first device of the devices is connected to a microphone to output a microphone input signal to the speech signal processing device. A second device of the devices is connected to a speaker to output a speaker output signal, which is the same as the signal output to the speaker, to the speech signal processing device. The speech signal processing device synchronizes a waveform included in the microphone input signal with a waveform included in the speaker output signal, and removes the waveform included in the speaker output signal from the waveform included in the microphone input signal.

### CLAIM OF PRIORITY

The present application claims priority from Japanese application JP 2016-221225 filed on Nov. 14, 2016, the content of which is hereby incorporated by reference into this application.

### BACKGROUND OF THE INVENTION

The present invention relates to a speech signal processing system and devices thereof.

### Background Art

As background art of this technical field, there is a technique that, when sounds generated by a plurality of sound sources are input to a microphone in a scene such as speech recognition or teleconference, extracts a target speech from the microphone input sounds.

For example, in a speech signal processing system (speech translation system) using a plurality of devices (terminals), the voice of a device user is the target voice, so that it is necessary to remove other sounds (environmental sound, voices of other device users, and speaker sounds of other devices). With respect to the sound emitted from a speaker of the same device, it is possible to remove sounds emitted from a plurality of speakers of the same device just by using the conventional echo cancelling technique (Japanese Patent Application Publication No. Hei 07-007557) (on the assumption that all the microphones and speakers are coupled at the level of electrical signal without via communication).

### SUMMARY OF THE INVENTION

However, it is difficult to effectively separate the sounds coming from other devices just by using the echo cancelling technique described in Japanese Patent Application Publication No. Hei 07-007557.

Thus, an object of the present invention is to separate individual sounds coming from a plurality of devices.

A representative speech signal processing system according to the present invention is a speech signal processing system including a plurality of devices and a speech signal processing device. Of the devices, a first device is coupled to a microphone to output a microphone input signal to the speech signal processing device. Of the devices, a second device is coupled to a speaker to output a speaker output signal, which is the same as the signal output to the speaker, to the sound signal processing device. The speech signal processing device is characterized by synchronizing a waveform included in the microphone input signal with a waveform included in the speaker output signal, and removing the waveform included in the speaker output signal from the waveform included in the microphone input signal.

### Advantageous Effects of Invention

According to the present invention, it is possible to effectively separate individual sounds coming from the speakers of a plurality of devices.

### BRIEF DESCRIPTION OF THE DRAWINGS

FIG. 1 is a diagram showing an example of the process flow of a speech signal processing device according to a first embodiment.

FIG. 2 is a diagram showing an example of a speech translation system.

FIG. 3 is a diagram showing an example of the speech translation system provided with the speech signal processing device.

FIG. 4 is a diagram showing an example of the speech signal processing device including a device.

FIG. 5 is a diagram showing an example of the connection between devices and a speech signal processing device.

FIG. 6 is a diagram showing an example of the connection of the speech signal processing device including the devices, to a device.

FIG. 7 is a diagram showing an example of the microphone input signal and the speaker output signal.

FIG. 8 is a diagram showing an example of the detection in a speaker signal detection unit.

FIG. 9 is a diagram showing an example of the detection in the speaker signal detection unit in a short time.

FIG. 10 is a diagram showing as example of the detection in the speaker signal detection unit by using a presentation sound.

FIG. 11 is a diagram showing an example in which a device includes a speech generation device.

FIG. 12 is a diagram showing an example in which a speech generation device is connected to a device.

FIG. 13 is a diagram showing an example in which a server includes the speech signal processing device and a speech generation device.

FIG. 14 is a diagram showing an example of resynchronization by each inter-signal time synchronization unit.

FIG. 15 is a diagram showing an example of the process flow of a speech signal processing device according to a second embodiment.

FIG. 16 is a diagram showing an example of the movement of a human symbiotic robot.

FIG. 17 is a diagram showing an example of the relationship between the distance from the sound source and the sound intensity.

### DETAILED DESCRIPTION OF THE INVENTION

Hereinafter, preferred embodiments of the present invention will be described with reference to the accompanying drawings. In each of the following embodiments, a description will be given of an example in which a processor executes a software program. However, the present invention is not limited to this example, and a part of the execution can be achieved by hardware. Further, the unit of process is represented by expressions such as system, device, and unit, but the present invention is not limited to these examples. A plurality of devices or units can be expressed as one device or unit, or one device or unit can be expressed as a plurality of devices or units.

### First Embodiment

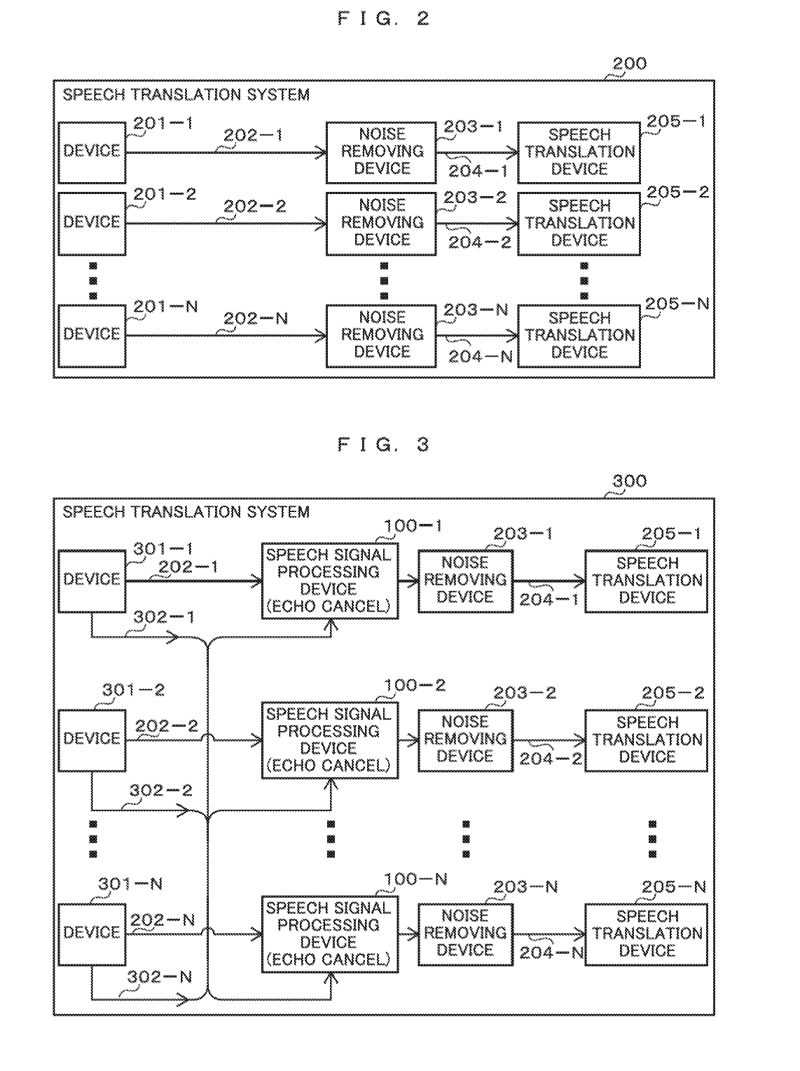

FIG. 2 is a diagram showing an example of a speech translation system 200. When sound is input to a device 201-1 provided with or connected to a microphone, the device 201-1 outputs a microphone input signal 202-1, which is obtained by converting the sound to an electrical signal, to a noise removing device 203-1. The noise removing device 203-1 performs no se removal on the microphone input signal 202-1, and outputs a signal 204-1 to a speech translation device 205-1.

The speech translation device 205-1 performs speech translation on the signal 204-1 including a voice component. Then, the result of the speech translation is output as a speaker output signal, not shown, from the speech translation device 205-1. Here, the process content of the noise removal and speech translation is unrelated to the configuration of the present embodiment described below, so that the description thereof will be omitted. However, well-known and popular processes can be used for this purpose.

The devices 201-2 and 201-N have the same description as the device 201-1, the microphone input signals 202-2 and 202-N have the same description as the microphone input signal 202-1, the noise removing devices 203-2 and 203-N have the same description as the noise removing device 203-1, the signals 204-2 and 204-N have the same description as the signal 204-1, and the speech translation devices 205-2 and 205-N have the same description as the speech translation device 205-1. Thus, the description thereof will be omitted. Note that N is an integer of two or more.

As shown in FIG. 2, the speech translation system 200 includes N groups of device 201 (devices 201-1 to 201-N are referred to as device 201 when indicated with no particular distinction between them, and hereinafter other reference numerals are represented in the same way), the noise removing device 203, and the speech translation device 205. These groups are independent of each other.

In each of the groups, a first language voice is input and a translated second language voice is output. Thus, when the device 201 is provided with or connected to a speaker, and when the second language voice translated by the speech translation device 205 is output in a state in which a plurality of devices 201 are located in the vicinity of each other in a conference or meeting, the second language voice may propagate through the air and may be input from the microphone together with the other first language voice.

In other words, there is a possibility that the second language voice output from the speech translation device 205-1 is output from the speaker of the device 201-1, propagates through the air and is input to the microphone of the device 201-2 located in the vicinity of the device 201-1. The second language voice included in the microphone input signal 202-2 may be the original signal, so that it is difficult to remove the second language voice by the noise removing device 203-2, which may affect the translation accuracy of the speech translation device 205-2.

Note that not only the second language voice output from the speaker of the device 201-1 but also the second language voice output from the speaker of the device 201-N may be input to the microphone of the device 201-2.

FIG. 3 is a diagram showing an example of a speech translation system 300 provided with a speech signal processing device 100. Those already described with reference to FIG. 2 are indicated by the same reference numerals and the description thereof will be omitted. A device 301-1, which is a device of the same type as the device 201-1, is provided with or connected to a microphone and a speaker to output a speaker output signal 302-1 that is output to the speaker, in addition to the microphone input signal 202-1.

For example, the speaker output signal 302-1 is a signal obtained by dividing the signal output from the speaker of the device 301-1. The output source of the signal can be within or outside the device 301-1. The output source of the speaker output signal 302-1 will be further described below with reference to FIGS. 11 to 13.

The speech signal processing device 100-1 inputs the microphone input signal 202-1 and the speaker output signal 302-1, performs an echo cancelling process, and outputs a signal, which is the processing result, to the noise removing device 203-1. The echo cancelling process will be further described below. The noise removing device 203-1, the signal 204-1, and the speech translation device 205-1, respectively, are the same as already described.

The devices 301-2 and 301-N have the same description as the device 301-1, the speaker output signals 302-2 and 302-N have the same description as the speaker output signal 302-1, and the speech signal processing devices 100-2 and 100-N have the same description as the speech signal processing device 100-1. Further, as shown in FIG. 3, each of the microphone input signals 202-1, 202-2, and 202-N is input to each of the speech signal processing devise 100-1, 100-2, and 100-N.

On the other hand, the speaker output signals 302-1, 302-I, 303-N are input to the speech signal processing device 100-1. In other words, the speech signal processing device 100-1 inputs the speaker output signal 302 output from a plural of devices 301. Then, similar the speech signal processing device 100-1, the speech signal processing devices 100-2 and 100-N also input the output signal 302 output from each of the devices 301.

In this way, the speech signal processing device 100-1, when the microphone of the device 301-1 picks up the sound wave output into the air from the speakers of the devices 301-1 and 301-N, in addition the sound wave output into the air from the speaker of the device 301-1. If influence appears in the microphone input signal 202-1, it is possible to remove the influence by using the speaker output signals 302-1, 302-2, and 302-N. The speech signal processing devices 100-2 and 100-N operate in the same way.

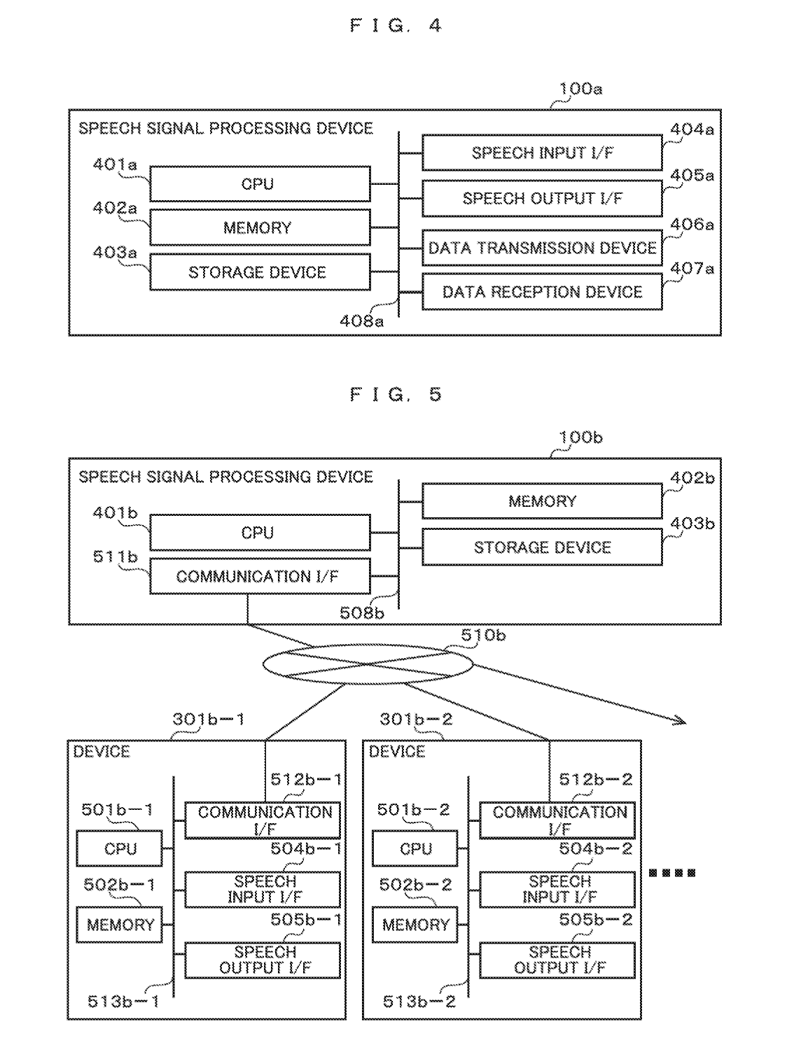

A hardware example of the speech signal processing device 100 and the device 301 will be described with reference to FIGS. 4 to 6. FIG. 4 is a diagram showing an example of a speech signal processing device 100a including the device 301. In the example of FIG. 3, the device 301 and the speech signal processing device 100 are shown as separate devices. However, the present invention is not limited to this example. It is also possible that the speech signal processing device 100 includes as the device 301 as the speech signal processing device 100a.

A CPU 401a may be a common central processing unit processor. A memory 402a is a main memory of the CPU 401a, which may be a semiconductor memory in which program and data are stored. A storage device 403a a non-volatile storage device such as, for example, HDD (hard disk drive), SSD (solid state drive), or a flash memory. The program and data may be stored in the storage device 403a as well as in the memory 402a, and may be transferred between the storage device 403a and the memory 402a.

A speech input I/F 404a is an interface that connects a voice input device such as a mic (microphone) not shown. A speech output I/F 405a is an interface that connects a voice output device such as a speaker not shown. A data transmission device 406a is a device for transmitting data to the other speech signal processing device 100a. A data receiving device 407a is a device for receiving data from the other speech signal processing device 100a.

Further, the data transmission device 406a can transmit data to the noise removing device 203, and the data receiving device 407a can receive data from the speech generation device such as the speech translation device 205 described below. The components described above are connected to each other by a bus 408a.

The program loaded from the storage device 403a to the memory 402a is executed by the CPU 401a. The data of the microphone input signal 202, which obtained through the speech input I/F, is stored in the memory 402a or the storage device 403a. Then, the data received by the data receiving device 407a is stored in the memory 402a or the storage device 403a. The CPU 401a performs a process such as echo cancelling by using the data stored in the memory 402a or the storage device 403a. Then, the CPU 401a transmits the data, which is the processing result, from the data transmission device 406a.

Further, as the device 301, the CPU 401a outputs the data received by the data receiving device 407a, or the data of the speaker output signal 302 stored in the storage device 403a, from the speech output I/F 405a.

FIG. 5 is a diagram showing an example of the connection between the device 301 and a speech signal processing device 100b. A CPU 401b, a memory 402b, and a storage device 403b, which are included in the speech signal processing device 100b, perform the operations respectively described for the CPU 401a, the memory 402a, and the storage device 403a. A communication I/F 511b is an interface that communicates with the devices 301b-1 and 301b-2 through a network 510b. A bus 508b connects the CPU 401b, the memory 402b, the storage device 403b, and the communication I/F 511b to each other.

A CPU 501b-1, a memory 502b-1, a speech input I/F 504b-1, and a speech output I/F 505b-1, which are included in the device 301b-1, perform the operations respectively described for the CPU 401a, the memory 402a, the speech input I/F 404a, and the speech output I/F 405a.

The communication I/F 512b-1 is an interface that communicates with the speech signal processing device 100b through the network 510b. The communication I/F 512b-1 can also communicate with the other speech signal processing device 100b not shown. Components included in the device 301b-1 are connected to each other by a bus 513b-1.

A CPU 501b-2, a memory 502b-2, a speech input I/F 504b-2, a speech output I/F 505b-2, a communication I/F 512b-2, and a bus 513b-2, which are included in the device 301b-2, perform the operations respectively described for the CPU 501b-1, the memory 502b-1, the speech input I/F 504b-1, the speech output I/F 505b-1, the communication I/F 512b-1, and the bus 513b-1. The number of devices 301b is not limited to two and may be three or more.

The network 510b may be a wired network or a wireless network. Further, the network 510b may be a digital data network or an analog data network through which electrical speech signals and the like are communicated. Further, although not shown, the noise removing device 203, the speech translation device 205, or a device for outputting speech signals or speech data may be connected to the network 510b.

In the device 301b, the CPU 510b executes the program stored in the memory 502b. In this way, the CPU 501b transmits the data of the microphone input signal 202 obtained by the speech input I/F 504b, to the communication I/F 511b from the communication I/F 512b through the network 510b.

Further, the CPU 501b outputs the data of the speaker output signal 302 received by the communication I/F 512b through the network 510b, from the speech output I/F 505b, and transmits to the communication I/F 511b from the communication I/F 512b through the network 510b. These processes of the device 301b are performed independently in the device 301b-1 and the device 301b-2.

On the other hand, in the speech signal processing device 100b, the CPU 401b executes the program loaded from the storage device 403b to the memory 402b. In this way, the CPU 401b stores the data of the microphone input signals 202, which are received by the communication I/F 511b from the devices 301b-1 and 301b-2, into the memory 402b or the storage device 403b. Also, the CPU 401b stores the data of the speaker output signals 302, which are received by the communication I/F 511b from the devices 301b-1 and 301b-2, into the memory 402b or the storage device 403b.

Further, the CPU 401b performs a process such as echo cancelling by using the data stored in the memory 402b or the storage device 403b, and transmits the data, which is the processing result, from the communication I/F 511b.

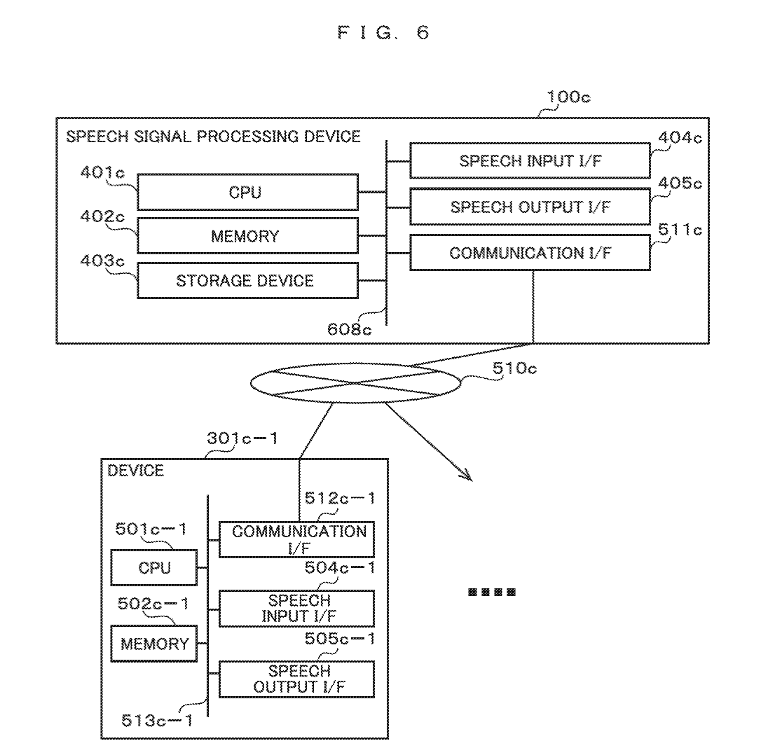

FIG. 6 is a diagram showing an example of the connection of the speech signal processing device 100c including the device 301, to the device 301c. A CPU 401c, a memory 402c, a storage device 403c, a speech input 1/F 404c, and a speech output I/F 405c, which are included in the speech signal processing device 100c, perform the operations respectively described for the CPU 401a, the memory 402a, the storage device 403a, the speech input I/F 404a, and the speech output I/F 405a. Further, a communication I/F 511c performs the operation described for the communication I/F 511b. The components included in the speech signal processing device 100c are connected to each other by a bus 608c.

A CPU 501c a memory 502c-1, a speech intuit I/F 504c-1, a speech output I/F 505c-1, a communication I/F 512c-1, and a bus 513c-1, which are included in the device 301c-1, perform the operations respectively described for the CPU 501b-1, the memory 502b-1, the speech input I/F 504b-a, the speech output I/F 505b-1, the communication I/F 512b-1, and the bus 513b-1. The number of devices 301c-1 is not limited to one and may be two or more.

A network 510c and a device connected to the network 510c are the same as described in the network 510b, so that the description thereof will be omitted. The operation by the CPU 501c-1 of the device 301c-1 is the same as the operation of the device 301b. In particular, the CPU 501c -1 of the device 301c-1 transmits the data of the microphone input signal 202, as well as the data of the speaker output signal 302 to the communication I/F 511c by the communication I/F 512c-1 through the network 510c.

On the other hand, in the speech signal processing device 100c, the CPU 401c executes the program loaded from the storage device 403c to the memory 402c. In this way, the CPU 401c stores the data of the microphone input signal 202, which is received by the communication I/F 511c from the device 301c-1, into the memory 402c or the storage device 403c. Also, the CPU 401c stores the data of the speaker output signal 302, which is received by the communication I/F 511c from the device 301c-1, into the memory 402c or the storage 403c.

Further, the CPU 401c stores the data of the microphone input signal 202 obtained by the speech input I/F 404c into the memory 402c or the storage device 403c. Then, the CPU 401c outputs the data of the speaker output signal 302 to be output by the speech signal processing device 100c receiving by the communication I/F 511c, or the data of the speaker output signal 302 stored in the storage device 403a, from the speech output I/F 405c.

Then, the CPU 401c performs a process such as echo cancelling by using the data stored in the memory 402c or the storage device 403c, and transmits the data, which is the processing result, from the communication I/F 511c.

In the following, the speech signal processing devices 100a to 100c described with reference to FIGS. 4 to 6 are referred as the speech signal processing device 100 when indicating with no particular distinction between them. Also, the devices 301b-1 and 301c-1 are referred to as the device 301-1 when indicating with no particular distinction between them. Further, the devices 301b-1, 301b-2, and 301c-1 are referred to as the device 301 when indicating with no particular distinction between them.

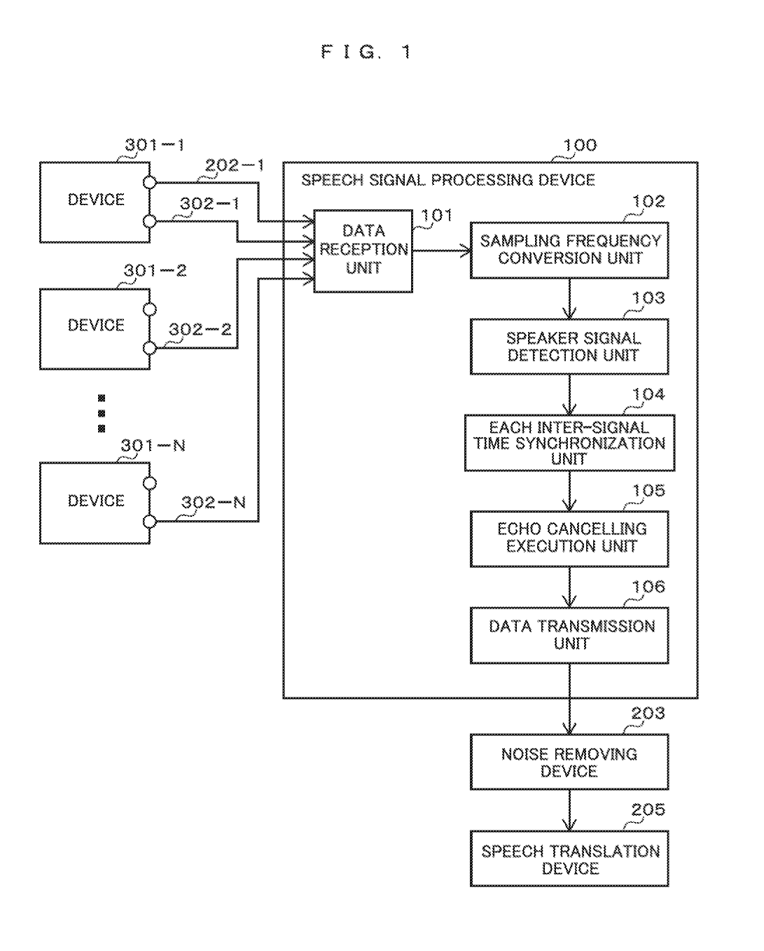

Next, the operation of the speech signal processing device 100 will be further described with reference to FIGS. 1 and 7 to 11. FIG. 1 is a diagram showing an example of the process flow of the speech signal processing device 100. The device 301, the microphone input signal 202, and the speaker output signal 302 are the same as already described. In FIG. 1, the speech signal processing device 100-1 shown in FIG. 3 shown as a representative speech signal processing device 100 for the purpose of explanation. However, there may also be possible that the speech signal processing device 100-2 or the like, not shown in FIG. 1, is present and the microphone input signal 202-2 or the like is input from the device 301-2.

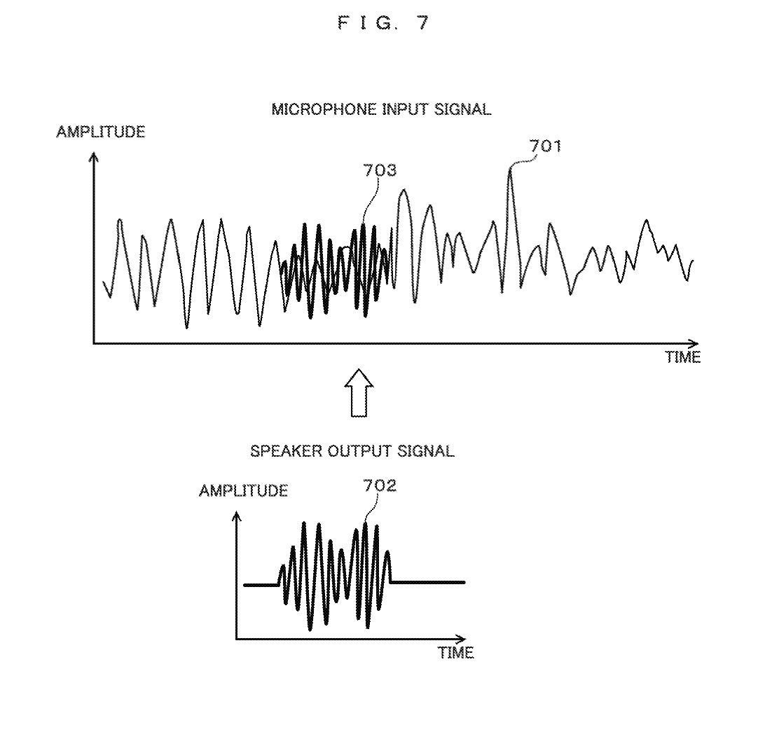

FIG. 7 is a diagram showing an example of the microphone input signal 202 and the speaker output signal 302. In FIG. 7, an analog-signal like expression is used for easy understanding. However, it may be an analog signal (an analog signal which is converted to a digital signal and then to an analog signal again), or may be a digital signal. The microphone input signal 202 is an electrical signal of the microphone provided in the device 301-1, or a signal obtained in such a way that the electrical signal is amplified and converted to a digital signal. The microphone input signal 202 has a waveform 701.

Further, the speaker output signal 302 is an electrical signal output from the speaker of the device 301, or is a signal obtained in such a way that the electrical signal is amplified and converted to a digital signal. The speaker output signal 302 has a waveform 702. Then, as already described above, the microphone of the device 301-1 also picks up the sound wave output into the air from the speaker of the device 301 and influence, such as a waveform 703, appears in the waveform 701.

In the example of FIG. 7, the waveform 702 and waveform 703 indicated by the solid line have the same shape for clear illustration. However, the waveform 703 is the synthesized waveform, so that the two waveforms do not necessarily have the same shape. Further, when the device 301 outputting the waveform 702 is the device 301-2, the other device 301, such as the device 301-N, affects the waveform 701 according to the same principle.

When the number of devices 301 is N, a data reception unit 101 shown in FIG. 1 receives one waveform 701 of the microphone input signal 202-1 as well as N waveforms 702 of the speaker output signals 302-1 to 302-N. Then, the data reception unit 101 outputs the received waveforms to a sampling frequency conversion unit 102. Note that the data reception unit 101 may be a process for controlling them by the data receiving device 407a, the communication I/F 511b, or the communication I/F 511c, and by the CPU 401.

In general, the sampling frequency of the signal input from a microphone and the sampling frequency of the signal output from a speaker may differ depending on the device including the microphone and the speaker. Thus, the sampling frequency conversion unit 102 converts the microphone input signal 202-1 input from the data reception unit 101 as well as a plurality of speaker output signals 302 into the same sampling frequency.

Note that when the signal on which the speaker output signal 302 is based is an analog signal such as an input signal from the microphone, the sampling frequency of the speaker output signal 302 is the sampling frequency of the analog signal. Further, when the signal on which the speaker output signal 302 is based is a digital signal from the beginning, the sampling frequency of the speaker output signal 302 may be defined as the reciprocal of the interval between a series of sounds that are represented by the digital signal.

For example, it is assumed that the microphone input signal 202-1 has a frequency of 16 KHz, the speaker output signal 302-2 has a frequency of 22 KHz, and the speaker output signal 302-N has a frequency of 44 KHz. In this case, the sampling frequency conversion unit 102 converts the frequencies of the speaker output signals 302-2 and 302-N into 16 KHz. Then, the sampling frequency conversion unit 102 outputs the converted signals to a speaker signal detection unit 103.

Of the converted signals, the speaker signal detection unit 103 detects the influence of the speaker output signal 302, from the microphone input signal 202-1. In other words, the speaker signal detection unit 103 detects the waveform 703 from the waveform 701 shown in FIG. 7, and detects the temporal position the waveform 703 within the waveform 701 because the waveform 703 is present in a part of the time axis of the waveform 701.

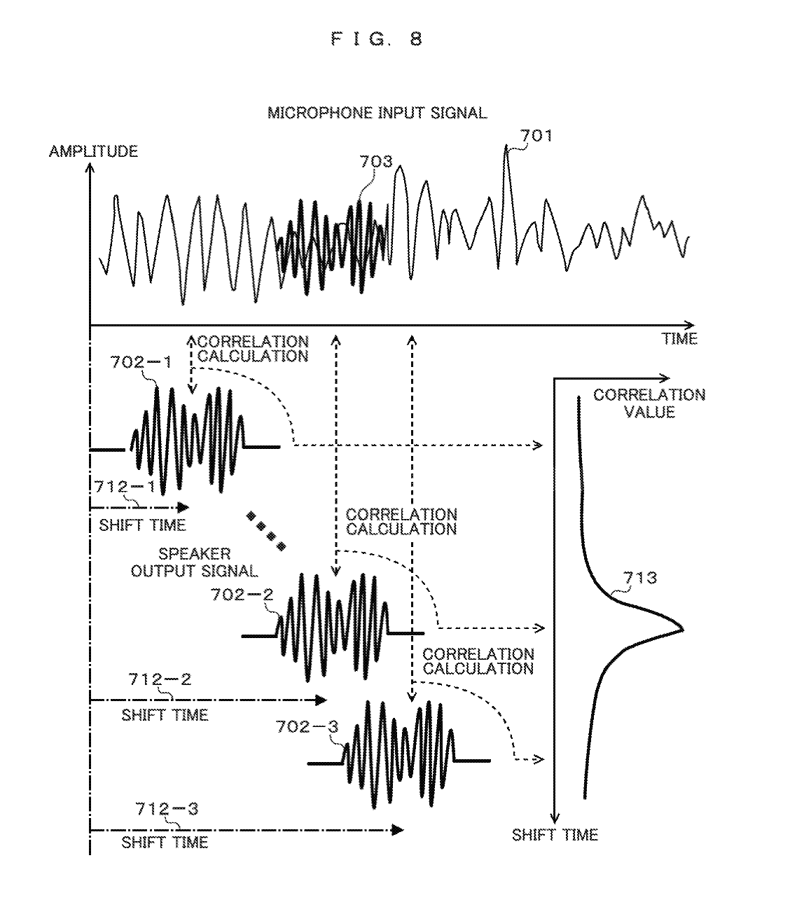

FIG. 8 is a diagram showing an example of the detection in the speaker signal detection unit 103. The waveforms 701 and 703 are the same as described with reference to FIG. 7. The speaker signal detection unit 103 delays the microphone input signal 202-1 (waveform 701) by a predetermined time. Then, the speaker signal detection unit 103 calculates the correlation between a waveform 702-1 of the speaker output signal 302, which is delayed by a shift time 712-1 that is shorter than the time by which the waveform 701 is delayed, and the waveform 701. Then, the speaker signal detection unit 103 records the calculated correlation value.

The speaker signal detection unit 103 further delays the speaker output signal 302 from the shift time 712-1 by a predetermined time unit, for example, a shift time 712-2 and a shift time 712-3. In this way, the speaker signal detection unit 103 repeats the process of calculating the correlation between the respective signals and recording the calculated correlation values. Here, in order to delay the speaker output signal 302 by the sift times 712-1, 712-2, and 712-3, the waveform 702-1, the waveform 702-2, and the waveform 702-3 have the same shape, which is the shape of the waveform 702 shown in FIG. 7.

Thus, the correlation value, which is the result or the calculation of the correlation between the waveform 701 and the waveform 702-2 delayed by the shift time 712-2 that is temporally close to the waveform 703 in which the waveform 702 is synthesized, is higher than the result of the calculation of the correlation between the waveform 701 and the waveform 702-1 or the waveform 702-3. In other words, the relationship between the shift time and the correlation value is given by a graph 713.

The speaker signal detection unit 103 identifies the shift time 712-2 with the highest correlation value as the time at which the influence of the speaker output signal 302 appears (or as the elapsed time from a predetermined time). While one speaker output signal 302 is described here, the speaker signal detection unit 103 performs the above process on the speaker output signals 302-1, 302-2, and 203-N to identify their respective times as the output of the speaker signal detection unit 103.

The longer the length of the waveform 702 used for the correlation calculation, or taking the opposite view, the longer the time for the correlation calculation of the waveform 702, the more time it will take for the correlation calculation. The process delay in the speaker signal detection unit 103 is increased, resulting in poor response from the input to the microphone the device 301-1 to the translation in the speech translation device 205. In other words, the real time property of translation is deteriorated.

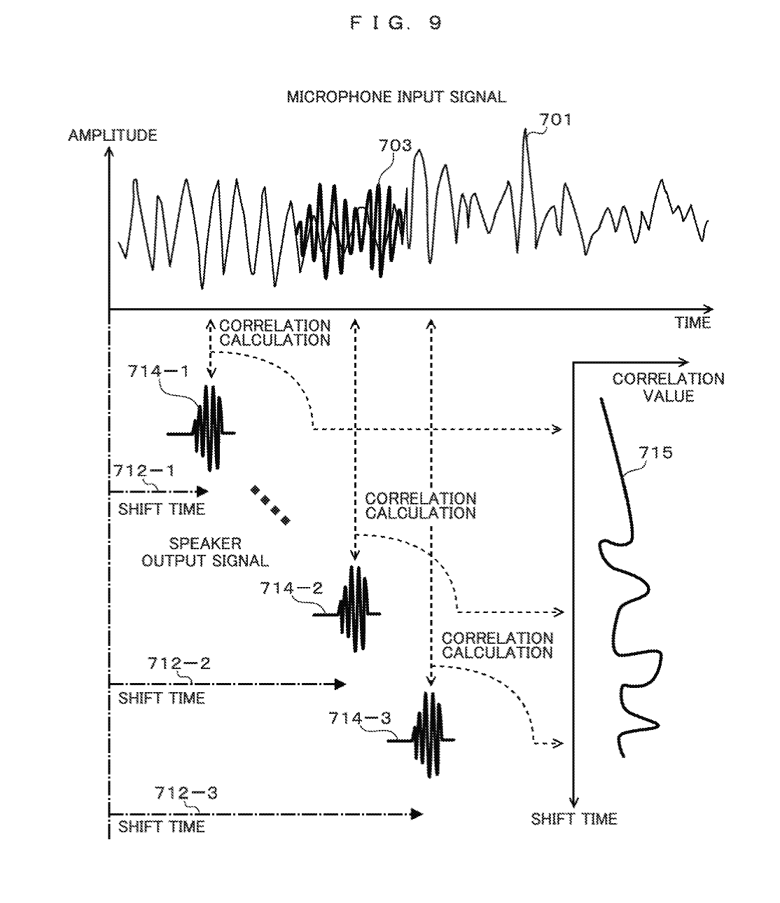

In order to make the correlation calculation short to improve the response, it is possible to reduce the time for the correlation calculation. However, if the time for the correlation calculation is made too short, the correlation value may be increased even with shift time that is different from the original. FIG. 9 is a diagram showing an example of the detection at a predetermined short time in the speaker signal detection unit 103. The shapes of waveforms 714-1, 714-2, and 714-3 are the same, and the time of the respective waveforms is shorter than the time of the waveforms 702-1, 702-2, and 702-3.

Then, as described with reference to FIG. 8, the speaker signal detection unit 103 calculates the correlation between the waveform 701 and each of the waveforms 714-1, 714-2, and 714-3, by delaying the respective waveforms by the shift times 712-1, 712-2, and 712-3. However, the waveform 714 is shorter than the waveform 703, so that the correlation value is not sufficiently high, for example, in the correlation calculation with a part of the waveform 703 in the shift time 712-2. In addition, even in parts other than the waveform 703, there is also a part where the correlation value increases because the wavelength 714 is short. The result is shown in a graph 715.

For this reason, it is difficult to identify the time at which the influence of the speaker output signal 302 appears in the speaker signal detection unit 103. Note that although the waveform itself is short in FIG. 9, the correlation values as the calculation result are unchanged if the time for the correlation calculation is reduced while the waveform itself has the same shape as the waveforms 702-1, 702-2, and 702-3.

Thus, in the present embodiment, in order to effectively identify the time at which the influence of the speaker output signal 302 appears, a waveform that can be easily detected is inserted into the top of the waveform 702 or waveform 714 to achieve both response and detection accuracy. The top of the waveform 702 or waveform 714 may be the top of the sound of the speaker of the speaker output signal 302. The top of the sound of the speaker may be the top after pause, which is a silent interval, or may be the top of the synthesis in the synthesized sound of the speaker.

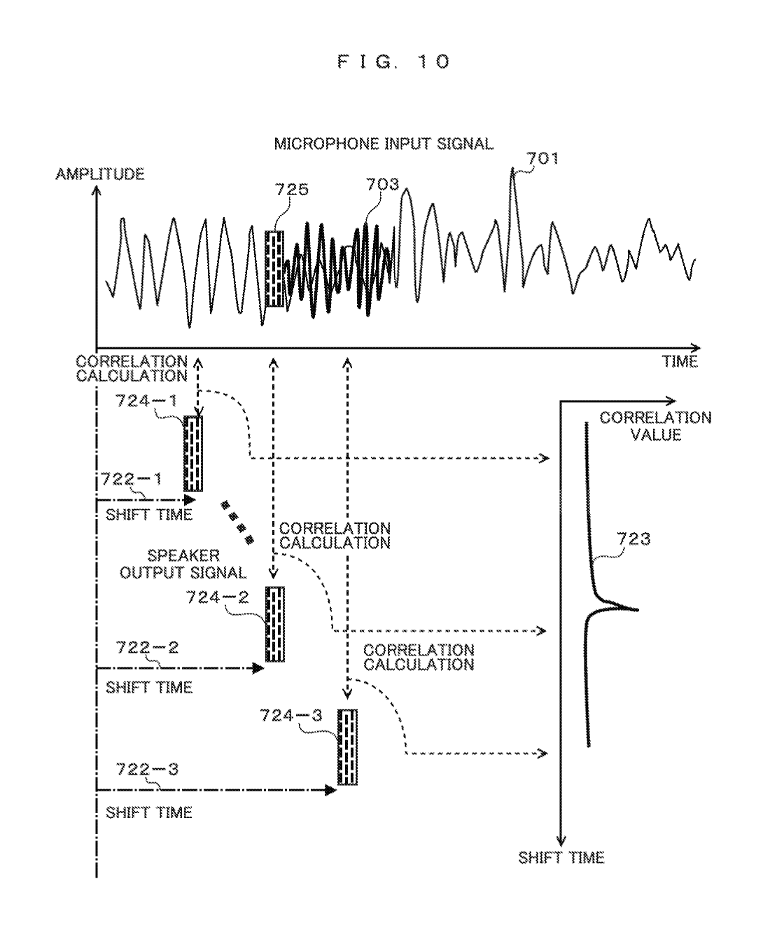

Further, the short waveform that can be easily detected includes pulse waveform, waveform of white noise, or machine sound with a waveform that is less related with a waveform such as voice. In the light of the nature of the translation system, a presentation sound “TUM” that is often used in the car navigation system is preferable. FIG. 10 is a diagram showing an example of the detection in the speaker signal detection unit 103 by using a presentation sound.

The shape of a waveform 724 of a presentation sound is greatly different from that of the waveform 701 except a waveform 725, so that the waveform 724 is illustrated as shown in FIG. 10. Here, in the speaker output signal 302, the waveform 702 or the waveform 714 may also be included, in audition to the waveform 724. However, the influence on the calculated correlation value is small, so that the waveform 702 or the waveform 714 is omitted in the figure. The waveform 724 itself is short and the time for the correlation calculation is also short.

Then, as described with reference to FIGS. 8 and 9, the speaker signal detection unit 103 calculates the correlation between the waveform 701 and each of the waveforms 724-1, 724-2, and 724-3 by delaying the respective waveforms by the shift times 722-1, 722-2, and 727-3. Then, the speaker signal detection unit 103 obtains the correlation values of a graph 723. In this way, it is possible to achieve both response and detection accuracy.

With respect to the response, it is possible to reduce the time until the correlation calculation is started. For this purpose, it is desirable that the waveform 702 of the speaker output signal 302 is available for the correlation calculation at the time when the signal component (waveform component) corresponding to the speaker output signal 302 such as the waveform 703 reaches the speaker signal detection unit 103.

For example, when the time relationship between the waveform 701 of the microphone input signal 202-1 and the waveform 702 of the speaker output signal 302 is as shown in FIG. 7, the relationship between the waveform 703 and the waveform 702-1 shown in FIG. 8 is not given, so that the waveform 701 is delayed by a predetermined time, which has been described above. However, the time until the start of the correlation calculation is delayed due to the delay of this waveform 701.

Instead of FIG. 7, if the time relationship between the waveform 703 and the waveform 702-1 shown in FIG. 8 from the input point of the waveform 702, namely, if the speaker output signal 302 reaches the speaker signal detention unit 103 faster than the microphone input signal 202-1, is possible to reduce the time until the start of the correlation calculation without the need to delay the waveform 701. The time relationship between the waveform 725 and the waveform 724-1 shown in FIG. 10 is also the same as the time relationship between the waveform 703 and the waveform 702-1.

FIG. 11 is a diagram showing an example in which the device 301 includes a speed generation device 802. The device 301-1 is the same as already described. The device 301-1 is connected to a microphone 801-1 and outputs the microphone input signal 202-1 to the speech signal processing device 100. The device 301-2 includes a speech generation device 802-2. The device 301-2 outputs a speech signal generated by the speech generation device 802-2 to a speaker 803-2. Then, the device 301-2 outputs the speech signal, as the speaker output signal 302-2, to the speech signal processing device 100.

The sound wave output from the speaker 803-2 propagates through the air. Then, the sound wave is input from the microphone 801-1 and affects the waveform 701 of the microphone input signal 202-1 as the waveform 703. In this way, there are two paths from the speech generation device 802-2 to the speech signal processing device 100. However, the relationship between the transmission times of the paths is not necessarily stable. In particular, the configuration described with reference to FIGS. 5 and 6 is also affected by the transmission time of the network 510.

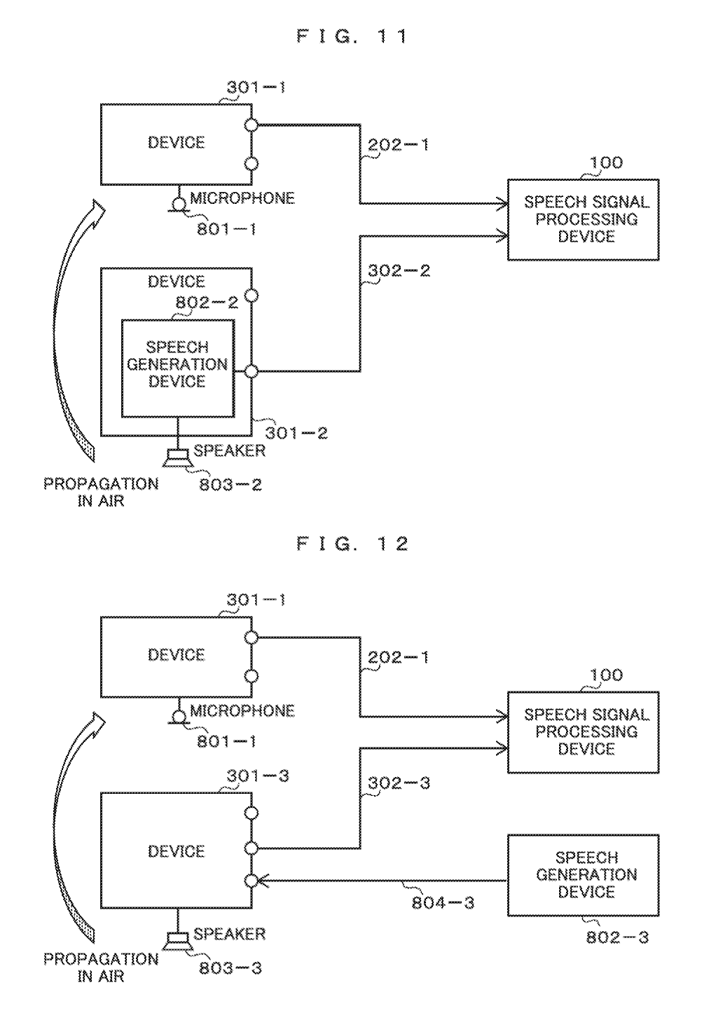

FIG. 12 is a diagram showing an example in which the speech generation device 802 is connected to the device 301. The device 301-1, the microphone 801-1, the microphone input signal 202-1, and the speech signal processing device 100 are the same as described with reference to FIG. 11, which are indicated by the same reference numerals and the description thereof will be omitted. A speech generation device 802-3 is equivalent to the speech generation device 802-2, which outputs sound signal 804-3 to a device 301-3.

Upon inputting the signal 804-3, the device 301-3 outputs the signal 804-3 to a speaker 803-3, or converts the signal 804-3 to a signal format suitable for the speaker 803-3 and then outputs to the speaker 803-3. Further, the device 301-3 just outputs the signal 804-3 to the speech signal processing device 100, or converts the signal 804-3 to a signal format of the speaker output signal 302-2 and then outputs to the speech signal processing device 100 as the speaker output signal 302-2. In this way, the example shown in FIG. 12 has the same paths as those described with reference to FIG. 11.

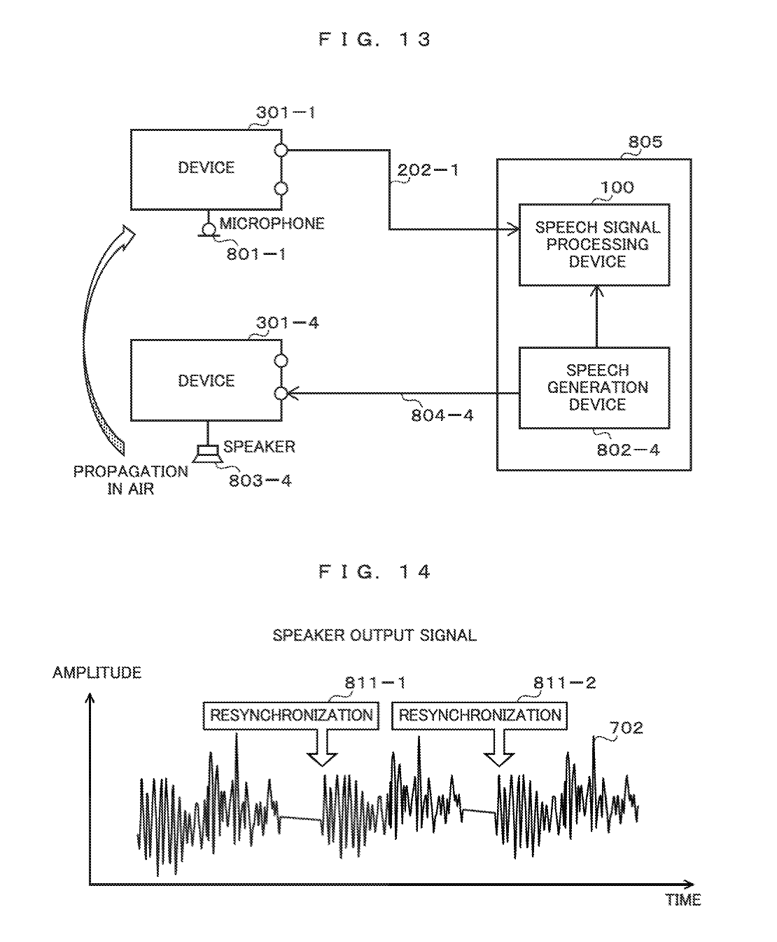

FIG. 13 diagram showing an example in which a server 805 includes the speech signal processing device 100 and the speech generation device 802-4. The device 301-1, the microphone 801-1, the microphone input signal 202-1, and the speech signal processing device 100 are the same as described with reference to FIG. 11, which are indicated by the same reference numerals and the description thereof will be omitted. Further, a device 301-4, a speaker 803-4, and a signal 804-4 respectively correspond to the device 301-3, the speaker 803-3, and the signal 804-3. However, the device 301-4 does not output to the speech signal processing device 100.

The speech generation device 802-4 is included in the server 805, similarly to the speech signal processing device 100. The speech generation device 802-4 outputs a signal corresponding to the speaker output signal 302 into the speech signal processing device 100. This ensures that the speaker output signal 302 is not delayed more than the microphone input signal 202, so that the response can be improved. Although FIG. 13 shows an example in which the speech signal processing device 100 and the speech generation device 802-4 are included in one server 805, the speech signal processing device 100 and the speech generation device 802-4 may be independent of each other as long as the data transfer speed between them is sufficiently high.

Note that even if the speaker output signal 302 is delayed more than the microphone input signal 202 in the configuration of FIGS. 11 and 12, the speaker signal detection unit 103 can identify the time relationship between the microphone input signal 202 and the speaker output signal 302 as already described with referenced to FIG. 8.

Returning to FIG. 1, each inter-signal time synchronization unit 104 inputs the information of the time relationship between the speaker output signal 302 and the microphone input signal 202 identified h the speaker signal detection unit 103, as well as the respective signals. Then, the each inter-signal time synchronization unit 104 corrects the correspondence relationship between the waveform of the microphone input signal 202 and the waveform of the speaker output signal 302 with respect to each waveform, and synchronizes the waveforms.

The sampling frequency of the microphone input signal 202 and the sampling frequency of the speaker output signal 302 are made equal by the sampling frequency conversion unit 102. Thus, out-of-synchronization should not occur after the synchronization process is performed once on the microphone input signal 202 and the speaker output signal 302 based on the information identified by the speaker signal detection unit 103 using the correlation between the signals.

However, even with the same sampling frequencies, the temporal correspondence relationship between the microphone input signal 202 and the speaker output signal 302 deviates a little due to the difference between the conversion frequency (the frequency of repeating the conversion from a digital signal to an analog signal) of DA conversion (digital analog conversion) when outputting to the speaker and the sampling frequency frequency repeating the conversion from an analog signal to a digital signal) of AD conversion (analog-digital conversion) when inputting from the microphone.

This deviation has small influence when the speaker sound of the speaker output signal 302 is short, but has significant influence when the speaker sound is long. Note that the speaker sound may be a unit in which sounds of the speaker are synthesized together. Thus, when the speaker sound is shorter than a predetermined time, the each inter-signal time synchronization unit 104 may just output the signal, which is synchronized based on the information from the speaker signal detection unit 103, to an echo cancelling execution unit 105.

Further, for example, when the content of the speaker output signal 302 is for the intercom, the speaker sound of the intercom is long. Thus, the each inter-signal time synchronization unit 104 further resynchronizes, at regular intervals, the signal that is synchronized based on the information from the speaker signal detection unit 103, and outputs to the echo cancelling execution unit 105.

The each inter-signal time synchronization unit 104 may perform resynchronization at predetermined time intervals as periodic resynchronization. Further, it may also be possible that the each inter-signal time synchronization unit 104 calculates the each inter-signal correlation at predetermined time intervals after performing synchronization based on the information from the speaker signal detection unit 103, constantly monitors the calculated correlation values, and performs resynchronization when the correlation value is lower than a predetermined threshold.

However, when the synchronization process is performed, the waveform is expanded and shrunk and a discontinuity occurs in the sound before and after the synchronization process, which may affect noise removal and speech recognition with respect to the sound before and after the synchronization process. Thus, the each inter-signal time synchronization unit 104 may measure the power of the speaker sound to perform resynchronization at the timing of detecting a rising amount of the power that exceeds a predetermined threshold. In this way, it is possible to avoid the discontinuity of the sound and prevent the reduction in the speech recognition accuracy, and the like.

FIG. 14 is a diagram showing an example of resynchronization by the each inter-signal time synchronization unit 104. The speaker output signal 302 is a speech signal or the like. As shown in the waveform 702, there are periods in which the amplitude is unchanged due to word or sentence breaks, breathing, and the like. The power rises each time after the periods in which the amplitude is unchanged, so that the each inter-signal time synchronization unit 104 detects this power and performs the process of resynchronization at the timing of respective resynchronizations 811-1 and 811-2.

Further, for the purpose of resynchronization, the presentation sound signal described with reference to FIG. 10 may be added to the speaker output signal 302 (and the microphone input signal 202 as influence on the speaker output signal 302). It is known that when the synchronization is performed between signals, higher accuracy can be obtained from a waveform containing a lot of noise components than from a clean sine wave. For this reason, by adding a noise component to the sound generated by the speech generation device 802, it is possible to add the noise component to the speaker output signal 302 and to obtain high time synchronization accuracy.

Further, when the frequency characteristics of the speaker output signal 302 and the frequency characteristics of the surrounding noise of the device 301-1 are similar to each other, the surrounding noise may be mixed into the microphone input signal 202. As a result, the process accuracy of the speaker signal detection unit 103 and the each inter-signal time synchronization unit 104, as well as the echo cancelling performance may be reduced. In such a case, it is desirable to filter the signal of the speaker output signal 302 to differentiate the frequency characteristics of the signal from the frequency characteristics of the surrounding noise.

Returning to FIG. 1, the echo cancelling execution unit 105 inputs the signal of the microphone input signal 202 that synchronized or resynchronized, as well as the signal of each speaker output signal 302, from the each inter signal time synchronization unit 104. Then, the echo cancelling execution unit 105 performs echo cancelling to separate and remove the signal of each speaker output signal 302 from the signal of the microphone input signal 202. For example, the echo cancelling execution unit 105 separates the waveform 703 from the waveform 701 in FIGS. 7 to 9, and separates the waveforms 703 and 725 from the waveform 701 in FIG. 10.

The specific process of echo cancelling is not a feature of the present embodiment, which has been widely known as echo cancelling that is widely used, so that the description thereof will be omitted. The echo cancelling execution unit 105 outputs the signal, which is the result of the echo cancelling, to a data transmission unit 106.

The data transmission unit 106 transmits the signal input from the echo cancelling execution unit 105 to the noise removing device 203 outside the speech signal processing device 100. As already described, the noise removing device 203 removes common noise, namely, the surrounding noise of the device 301 as well as sudden noise, and outputs the resultant signal to the speech translation device 205. Then, the speech translation device 205 translates the speech included in the signal. Note that the noise removing device 203 may be omitted.

The speech signal translated by the speech translation device 205 may be output to part of the devices 301-1 to 301-N as the speaker output signal, or may be output to the data reception unit 101 as a replacement for part of the speaker output signals 302-1 to 302-N.

As described above, the signal of the sound output from the speaker of the other device can surely be obtained and applied to echo cancelling, so that it is possible to effectively remove unwanted sound. Here, the sound output from the speaker of the other device propagates through the air and reaches the microphone, which is then converted to microphone input signal. Thus, there is a possibility that a time difference will occur between the microphone input signal and the speaker output signal. However, the microphone input signal and the speaker output signal are synchronized with each other, making it possible to increase the removal rate by echo canceling.

Further, the speaker output signal can be obtained in advance in order to reduce the process time for synchronizing the microphone input signal with the speaker output signal. In addition, by adding a presentation sound to the speaker output signal, it is possible to increase the accuracy of the synchronization between the microphone input signal and the speaker output signal to reduce the process time. Also, because sounds other than speech to be translated can be removed, it is possible to increase the accuracy of speech translation.

### Second Embodiment

The first embodiment has described an example of pre-processing for speech translation at a conference or meeting. The second embodiment describes an example of pre-processing for voice recognition by a human symbiotic robot. The human symbiotic robot in the present embodiment is a machine that moves to the vicinity of a person, picks up the voice of the person by using a microphone of the human symbiotic robot, and recognizes the voice.

In such a human symbiotic robot, highly accurate voice recognition is required in the real environment. Thus, removal of sound from a specific sound source, which is one of the factors affecting voice recognition accuracy and varies according to the movement of the human symbiotic robot, is effective. The specific sound source in the real environment includes, for example, speech of other human symbiotic robots, voice over an intercom, and internal noise of the human symbiotic robot itself.

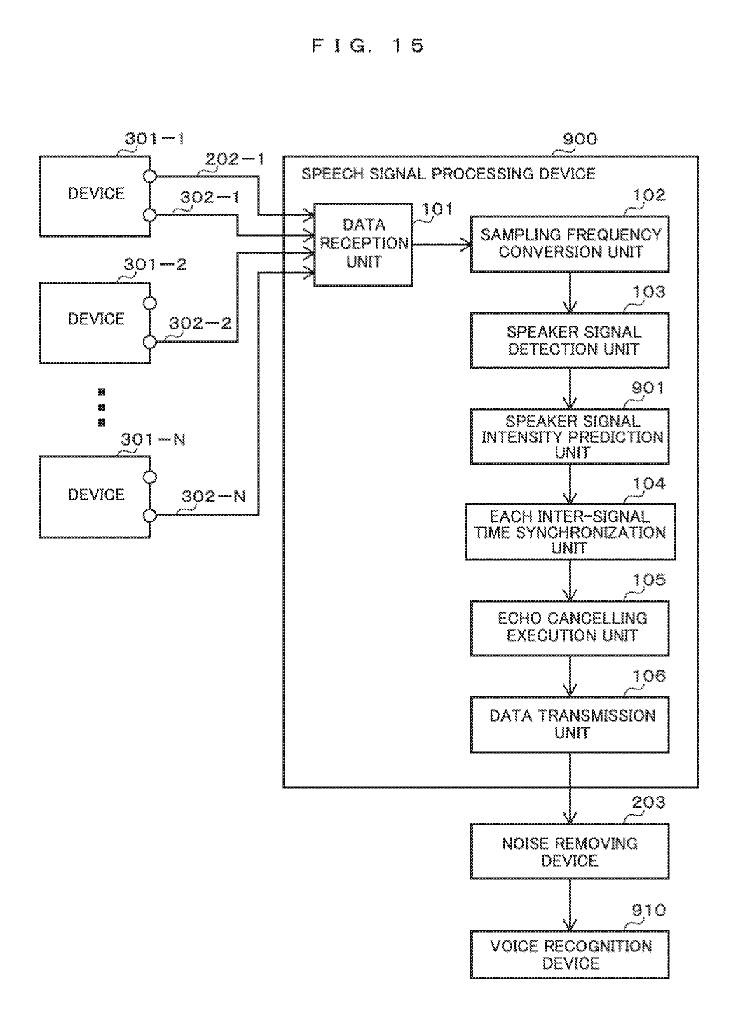

FIG. 15 is a diagram showing an example of the process flow of a speech signal processing device 900. The same components as in FIG. 1 are indicated by the same reference numerals and the description thereof will be omitted. The speech signal processing device 900 is different from the speech signal processing device 100 described in the first embodiment in that the speech signal processing device 900 includes a speaker signal intensity prediction unit 901. However, this is a difference in process. The speech signal processing device 900 may include the same hardware as the speech signal processing device 100, for example, shown in FIGS. 4 to 6 and 11 to 13.

Further, a voice recognition device 910 is connected instead of the speech translation device 205. The voice recognition device 910 recognizes voice to control physical behavior and speech of a human symbiotic robot, or translates the recognized voice. The device 301-1, the speech signal processing device 900, the noise removing device 203, the voice recognition device 910 may also be included in the human symbiotic robot.

Of the specific sound sources, the internal noise of the human symbiotic robot itself, particularly, the motor sound significantly affects the microphone input signal 202. Nowadays, high-performance motors with low operation sound are also present. Thus, it is possible to reduce the influence on the microphone input signal 202 by using such a high-performance motor. However, the high-performance motor is expensive, that the cost of the human symbiotic robot will increase.

On the other hand, if a low-cost motor is used, it is possible to reduce the cost of the human symbiotic robot. However, the operation sound of the low-cost motor is large and has significant influence on the microphone input signal 202. Further, in addition to the magnitude of the operation sound of the motor itself, the vibration on which the operation sound of the motor is based is transmitted to the body of the human symbiotic robot and input to a plurality of microphones. It is more difficult to remove such an operation sound than the airborne sound.

Thus, a microphone (voice microphone or vibration microphone) is placed near the motor, and a signal obtained by the microphone is treated as one of a plurality of speaker output signals 302. The signal obtained by the microphone near the motor is not the signal of the sound output from the speaker, but includes a waveform highly correlated with the waveform included in the microphone input signal 202. Thus, the signal obtained by the microphone near the motor can be separated by echo cancelling.

Thus, for example, it is possible that the microphone, not shown, of the device 301-N may be placed near the motor and the device 301-N outputs the signal obtained by the microphone to the speaker output signal 302-N.

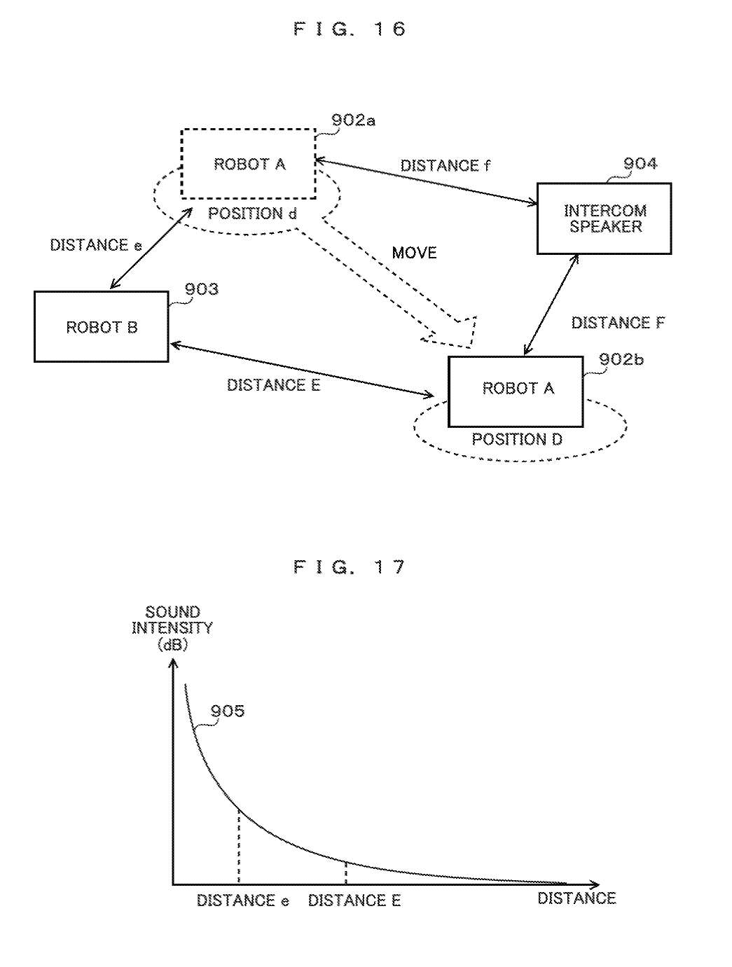

FIG. 16 is a diagram showing an example of the movement of human symbiotic robots. A robot A902 and a robot B903 are human symbiotic robots. The robot A902 moves from a position d to a position D. Here, the point at which the robot A902 is present at the position d is referred to as robot A902a, and the point at which the robot A902 is present at the position D is referred to as robot A902b. The robot A902a and the robot A902b are the same robot A902 from the perspective of the object, and the difference is in the time at which the robot A is present.

The distance between the robot A902a and the robot B903 is a distance e. However, when the robot A902 moves from the position d to the position D, the distance between the robot A902b and the robot B903 becomes a distance E, so that the distance varies from the distance e to the distance E. Further, the distance between the robot A902a and an intercom speaker 904 is a distance f. However, when the robot A902 moves from the position d to the position D, the distance between the robot A902b and the intercom speaker 904 becomes a distance F, so that the distance varies from the distance f to the distance F.

In this way, since the human symbiotic robot (robot A902) moves freely, the distance bet eel the other human symbiotic robot (robot B903) and the device 301 (intercom speaker 904) which placed in a fixed position varies, and as a result the amplitude of the waveform of the speaker output signal 302 included in the microphone input signal 202 varies.

If the amplitude of the waveform of the speaker output signal 302 included in the microphone input signal 202 is small, the synchronization of the speaker signal as well as the performance of echo cancelling may deteriorate. Thus, the speaker signal intensity prediction unit 901 calculates the distance from the position of each of a plurality of devices 301 to the device 301. When it is determined that the amplitude of the waveform of the speaker output signal 302 included in the microphone input signal 202 is small, the speaker signal intensity prediction unit 901 does not perform echo cancelling on the signal of the particular speaker output signal 302.

The speaker signal intensity prediction unit 901 or the device 301 measures the position of the speaker signal intensity prediction unit 901, namely, the position of the human symbiotic robot by means of radio or sound waves, and the like. Since the measurement of position using radio or sound waves, and the like, has been widely known and practiced, the description leaves out the content f the process. Further, the speaker signal intensity prediction unit 901 within the device placed in a fixed position such as the intercom speaker 904 may store a predetermined position without measuring the position.

The human symbiotic robot and the intercom speaker 904, and the like, may mutually communicate and store the information of the measured position to calculate the distance based on the interval between two positions. Further, it is also possible that the human symbiotic robot and the intercom speaker 904, and the like, mutually emit radio or sound waves, and the like, to measure the distance without measuring the position.

For example, in a state in which there is no sound in the vicinity before actual operation, sounds are sequentially output from the speakers such as the human symbiotic robot and the intercom speaker 904. At this time, the speaker signal intensity prediction unit 901 of each device not outputting sound records the distance from the device outputting sound, as well as the sound intensity (the amplitude of the waveform.) of the microphone input signal 202. The speaker signal intensity prediction unit 901 repeats the recording by changing the distance, and records voice intensities at a plurality of distances. Alternatively, the speaker signal intensity prediction unit 901 calculates voice intensities at each of a plurality of distances from the attenuation rate of sound waves in the air, and generates information showing the graph of a sound attenuation curve 905 shown in FIG. 17.

FIG. 17 is a diagram showing an example of the relationship between the distance from the sound source and the sound intensity. Each time the human symbiotic robot moves (each time the position and distance change), the speaker signal intensity prediction unit 901 of the human symbiotic robot or the intercom speaker 904, and the like, calculates the distance from the other device. Then, the speaker signal intensity prediction unit 901 obtains the sound intensities based on the respective distances in the sound attenuation curve 905 shown in FIG. 17.

Then, the speaker signal intensity prediction unit 901 outputs, to the echo cancelling execution unit 105, the signal of the speaker output signal 302 with a sound intensity higher than a predetermined threshold. At this time, the speaker signal intensity prediction unit 901 does not output, to the echo cancelling execution unit 105, the signal of the speaker output signal 302 with a sound intensity lower than the predetermined threshold. In this way, it is possible to prevent the deterioration of the signal due to unnecessary echo cancelling.

In FIG. 16, when the robot A902 moves from the position d to the position D in order to obtain the voice intensities, the distance between the robot A902 and the robot B903 changes from the distance e to the distance E. Thus, the sound intensity each distance can be obtained from the sound attenuation curve 905 shown in FIG. 17. Here, the sound intensity higher than the threshold is obtained at the distance e and echo cancelling is performed, but the sound intensity is lower than the threshold at the distance E and echo cancelling is not performed.

Note that in order to further accurately predict the sound intensity, the transmission path information and the sound volume of the speaker, or the like, may be used in addition to the distance. Further, the distance between to the speaker of the device 301-1 to which a microphone is connected as well as the microphone of the device 301-N placed near the motor does not change when the human symbiotic robot moves, so that the speaker output signal 302-1 and the speaker output signal 302-N may be removed from the process target of the speaker signal intensity prediction unit 901.

As described above, with respect to the human symbiotic robot moving by a motor, it is possible to effectively remove the operation sound of the motor. Further, even if the distance from the other sound source changes due to movement, it is possible to effectively remove the sound from the other sound source. In particular, the signal of the voice to be recognized is not affected by removal more than necessary. Further, sounds other than the voice to be recognized can be removed, so that it is possible to increase the recognition rate of the voice.

What is claimed is:

1. A speech signal processing system comprising a plurality of devices and a speech signal processing device,
wherein, of the devices, a first device is connected to a microphone to output a microphone input signal to the speech signal processing device,
wherein, of the devices, a second device is connected to a speaker output a speaker output signal, which is the same as the signal output to the speaker, to the speech signal processing device,
wherein the speech signal processing device synchronizes a waveform included in the microphone input signal with a waveform included in the speaker output signal, and
wherein the speech signal processing device removes the waveform included in the speaker output signal from the waveform included in the microphone input signal.

2. The speech signal processing system according to claim 1,
wherein, of the devices, a third device is connected to a third speaker to output a third speaker output signal, which is the same as the signal output to the third speaker, to the speech signal processing device,
wherein the speech signal processing device synchronizes the waveform included in the microphone input signal with a waveform included in the third speaker output signal, and
wherein the speech signal processing device removes the waveform included in the third speaker output signal from the waveform included in the microphone input signal.

3. The speech signal processing system according to claim 1,
wherein the speech signal processing device converts the microphone input signal or the speaker output signal so that a sampling frequency of the microphone input signal and a sampling frequency of the speaker output signal are converted to a single frequency,
wherein speech signal processing device identifies the time relationship between the waveform of the converted microphone input signal and the waveform of the speaker output signal based on a calculation of the correlation between the waveform of the converted microphone input signal and the waveform of the speaker output signal, or identifies the time relationship between the waveform of the microphone input signal and the waveform of the converted speaker output signal based on a calculation of the correlation between the waveform of the microphone input signal and the waveform of the converted speaker output signal, and
wherein the speech signal processing device synchronizes the waveforms by using the identified time relationship.

4. The speech signal processing system according to claim 3,
wherein the speech signal processing device measures power of the speaker output signal or power of the converted speaker output signal, and synchronizes the waveforms by also using the measured power.

5. The speech signal processing system according to claim 4,
wherein the signal to the speaker that is output by the second device, as well as the speaker output signal include a presentation sound signal with a waveform having low correlation with the voice waveform.

6. The speech signal processing system according to claim 5,
wherein the signal to the speaker that is output by the second device, as well as the speaker output signal include a signal of a sound containing a noise component that is different from surrounding noise of the first device.

7. The speech signal processing system according to claim 3,
wherein the second device outputs the speaker output signal to the speech signal processing device before outputting the speaker output signal to the speaker.

8. The speech signal processing system according to claim 7, further comprising a server including the speech signal processing device and a speech generation device,
wherein the second device inputs the speaker output signal from the speech generation device,
wherein the speech generation device outputs the speaker output signal to the second device, and
wherein the speech generation device outputs tree speaker output signal to the speech signal processing device instead of the second device.

9. The speech signal processing system according to claim 2, further comprising a speech translation device,
wherein the speech signal processing device outputs the microphone input signal in which the waveform included in the speaker output signal is removed to the speech translation device,
wherein the speech translation device inputs, from the speech signal processing device, the microphone input signal in which the waveform included in the speaker output signal is removed, translates the microphone input signal to generate speech, and outputs to the third device, and
wherein the third device treats the translated speech as the third speaker output signal.

10. The speech signal processing system according to claim 1, further comprising a robot including the first device, a fourth device, and a motor for movement,
wherein the fourth device is connected to a fourth microphone that picks up sound of the motor for movement, and outputs a signal input by the fourth microphone, as a fourth speaker output signal, to the speech signal processing device,
wherein the speech signal processing device synchronizes the waveform included in the microphone input signal with the waveform included in the fourth speaker output signal, and
wherein the speech signal processing device further removes the waveform included in the fourth speaker output signal from the waveform included in the microphone input signal.

11. The speech signal processing system according to claim 10,
wherein the speech signal processing device identifies an amplitude of the waveform included in the speaker output signal according to a distance between the first device and the second device, to determine execution of the removal of the waveform included in the speaker output signal.

12. A speech signal processing device into which signals are input from a plurality of devices,
wherein the speech signal processing device inputs a microphone input signal from a first device of the devices,
wherein the speech signal processing device inputs a speaker output signal, which is the same as the signal output to the speaker, from a second device of the devices,
wherein the speech signal processing device synchronizes a waveform included in the microphone input signal with a waveform included in the speaker output signal, and
wherein the speech signal processing device removes the waveform included in the speaker output signal from the waveform included in the microphone input signal.

13. The speech signal processing device according to claim 12,
wherein the speech signal processing device inputs a third speaker output signal, which is the same as the signal output to a third speaker from a third device of the devices,
wherein the speech signal processing device further synchronizes the waveform included in the microphone input signal with a waveform included in the third speaker output signal, and
wherein the speech signal processing device further removes a waveform included in the third speaker output signal from the waveform included in the microphone input signal.

14. The speech signal processing device according to claim 12,
wherein the speech signal processing device converts the microphone input signal or the speaker output signal so that a sampling frequency of the microphone input signal and a sampling frequency of the speaker output signal are converted to a single frequency,
wherein the speech signal processing device identifies the time relationship between the waveform of the converted microphone input signal and the waveform of the speaker output signal based on a calculation of the correlation between the waveform of the converted microphone input signal and the waveform of the speaker output signal, or identities the time relationship between the waveform of the microphone input signal and the waveform of the converted speaker output signal based on a calculation of the correlation between the waveform of the microphone input signal and the waveform of the converted speaker output signal, and
wherein the speech signal processing device synchronizes the waveforms by using the identified time relationship.

15. The speech signal processing device according to claim 14,
wherein the speech signal processing device measures power of the speaker output signal or power of the converted speaker output signal, to synchronize the waveforms by also using the measured power.
